(19) United States
(12) Patent Application Publication
(10) Pub. No.: US 2026/0111723 A1
(43) Pub. Date: Apr. 23, 2026

(54) DATA COMPRESSION AND MATCHING TECHNIQUES FOR HIGH-DIMENSIONAL DATA PROCESSING

(71) Applicant: Optum, Inc., Minnetonka, MN (US)

(72) Inventors: Elizabeth M. SMITH, Saint Paul, MN (US); Sanjit Singh BATRA, Millbrae, CA (US); Michael P. LAHM, Minneapolis, MN (US); Robert Elliott TILLMAN, Long Island City, NY (US)

(21) Appl. No.: 18/922,263

(22) Filed: Oct. 21, 2024

(51) Int. Cl. G06N 3/08; G06N 3/0455

(52) U.S. Cl. CPC G06N 3/08; G06N 3/0455

(57) ABSTRACT

Various embodiments of the present disclosure provide data compression, retrieval, and matching techniques that leverage latent representations to improve the functionality of a computer in various aspects. The techniques apply a multi-stage data compression technique to transform input data into binarized feature vector and latent representation pairs. These reference entries may be stored within a reference dataset and accessed to process data matching requests at improved processing speeds. To do so, the data matching techniques comprise receiving a data matching request that identifies a first reference entry from the reference dataset, determining a matching score for a second reference entry from the reference dataset based on the latent representation, and outputting, based on the matching score, the second reference entry in response to the data matching request.

### BACKGROUND

Various embodiments of the present disclosure address technical challenges of existing data matching, storage, and retrieval techniques in large-scale datasets. In many domains, identifying and extracting related data entries from a large-scale dataset presents several technical challenges, in part, due to noise presented within feature rich environments (e.g., the “curse of dimensionality”). To address robust feature sets, some traditional data retrieval techniques use scalar propensity scores, which summarize a similarity of data entries based on their features. Such techniques reduce the dimensionality of matching outputs but fail to provide sufficient granularity for effective matching and result in loss of valuable information. Alternative approaches have attempted to match based on entire covariate feature vectors. However, these techniques are computationally expensive and rely on false assumptions of equal weighting across all features.

Various embodiments of the present disclosure make important contributions to data matching, storage, and retrieval technologies by addressing these technical challenges, among others.

### BRIEF DESCRIPTION OF THE DRAWINGS

FIG. 1 depicts an example overview of an architecture in accordance with some embodiments of the present disclosure.

FIG. 2 depicts an example predictive data analysis computing entity in accordance with some embodiments of the present disclosure.

FIG. 3 depicts an example client computing entity in accordance with some embodiments of the present disclosure.

FIG. 4 depicts a dataflow diagram of a compressed data matching technique in accordance with some embodiments of the present disclosure.

FIG. 5 depicts an operational example of an encoder-decoder machine-learned model in accordance with some embodiments of the present disclosure.

FIG. 6 depicts a flowchart diagram of an example data matching process in accordance with some embodiments of the present disclosure.

FIG. 7 depicts a flowchart diagram of an example, multi-stage data compression process in accordance with some embodiments of the present disclosure.

### DETAILED DESCRIPTION

Various embodiments of the present disclosure address technical challenges with data matching, storage, and retrieval technologies by leveraging latent representations to enable more accurate, scalable, and flexible data retrieval and matching at a fraction of the computation cost relative to traditional approaches. To do so, some embodiments of the present disclosure provide latent representation-based data retrieval and a multi-staged data compression processes that collectively address technical challenges in effectively comparing, storing, and retrieving high-dimensional data. The multi-staged data compression process, for example, leverages an encoder-decoder machine learned model, such as a variational autoencoder (VAE) model, to generate lower-dimensional latent representations (e.g., a numerical vector representation that is represents an input to a machine learning model as interpreted by the machine learning model) from input data, enabling more efficient and accurate data matching across high dimensional features at reduced the memory requirements. To overcome performance deficiencies with traditional matching approaches used within high-dimensional feature spaces, the latent representation-based data retrieval process leverages latent representations to generate matching scores reflective of a similarity of data entries at a lower-dimensional level. By doing so, the latent representation-based data retrieval and a multi-staged data compression processes enable data matching using lower-dimensional representations that capture essential features of the input data. In this manner, some embodiments of the present disclosure may enable more nuanced comparisons between entities within a high-dimensional environment that result in data retrieval accuracy improvements at a fraction of the computational and memory usage requirement of traditional approaches.

In some embodiments of the present disclosure, the multi-staged data compression process is leveraged to generate and continuously update a reference dataset to accurately represent a high-dimensional environment. To do so, the multi-staged data compression process may apply feature extraction techniques, at a first stage, to generate high-dimensional binarized feature vectors (e.g., a one-hot encoding or other form of binary vector that indicates a presence or absence of a set of defined features, such as ICD-10 codes in a healthcare example) from data records, entries, and/or other feature dense materials. These binarized feature vectors may be leveraged, at a second stage, to train an encoder-decoder machine learned model (e.g., VAE model) to reconstruct the high dimensional vector from a low dimensional latent space. By doing so, the encoder-decoder machine-learned model may be trained to compress high-dimensional binarized feature vectors into lower dimensional latent representations, without reducing the predictiveness of the binarized feature vectors. At a third stage, a high-dimensional binarized feature vector may be input to a trained encoder-decoder machine-learned model (e.g., VAE model) to generate a latent representation that may be stored, in the reference dataset, with its corresponding binarized feature vector. This process may be repeated for up to each of a set of high-dimensional binarized feature vectors. By doing so, the multi-staged data compression process may compress high-dimensional feature vectors into lower-dimensional representations that may be linked back to their higher-dimensional counterparts. In this manner, a set of high-dimensional feature vectors from a reference dataset may be used to identify a target data entry, while a set of lower-dimensional latent representations may be used to expand the target data entry through lower dimensional similarity comparisons (e.g., matching scores). Ultimately, this improves data retrieval speeds, while reducing memory requirements relative to traditional data matching approaches.

In some embodiments of the present disclosure, a latent representation-based data retrieval process is leveraged to improve data retrieval speeds within a high-dimensional feature environment. The latent representation-based data retrieval process may receive a data matching or data similarity request that identifies a first reference entry from a reference dataset based on the reference entry's high-dimensional binarized feature vector. The latent representation-based data retrieval process may leverage the latent representation of the first reference entry to generate a plurality of matching scores for up to each of a plurality of second reference entities within the reference dataset. Based on these matching scores, the latent representation-based data retrieval process may expand the first reference entry with similar second reference entries and output the expanded entry set in response to the data matching request. By doing so, the latent representation-based data retrieval process may synthesize the interpretability and feature rich attributes of high-dimensional binarized feature vectors with the improved data comparison and compression attributes of latent representations to improve a data retrieval process relative to traditional approaches. In this way, some embodiments of the present disclosure enable improved data matching capabilities that may handle high-dimensional input data more efficiently and accurately than traditional methods. This, in turn, allows for more effective identification of similar entities across large datasets, with applications in various domains requiring sophisticated data comparison and matching functionalities.

Examples of technologically advantageous embodiments of the present disclosure comprise improved data compression, storage, and retrieval techniques that decrease the time to retrieve data, decrease electronic data size of stored data, and correspondingly decrease network transmission usage. The improved data compression, storage, and retrieval techniques are specifically designed for a computer to improve the storage functionality of the computer. By doing so, the technologically advantageous embodiments of the present disclosure enable the performance of traditionally complex, server side operations, on client devices with limited processing and memory capability. Other technical improvements and advantages, including those related to machine learning inference and training, may also be realized by one of ordinary skill in the art.

### I. Overview of Embodiments

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

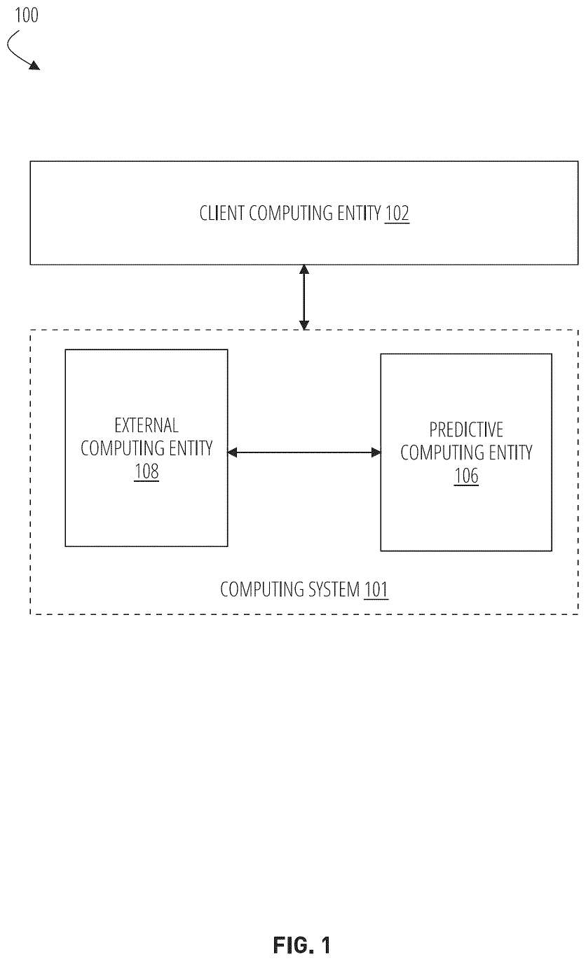

FIG. 1 depicts an example overview of an architecture 100 in accordance with some embodiments of the present disclosure. The architecture 100 comprises a computing system 101 configured to receive data, such as data records, data entries, and/or the like, and/or communications, such as data matching requests, and/or the like, from client computing entities 102, process the data and/or communications according to a data matching process, and provide responses to the client computing entities 102. The example architecture 100 may be used in a plurality of domains and is not limited to any specific application as disclosed herewith. The plurality of domains may comprise healthcare, industrial, manufacturing, computer security, to name a few.

In accordance with various embodiments of the present disclosure, one or more machine learned models may be trained to generate predictive outputs and/or other machine learned outputs. The models may be adapted to a data matching and/or multi-staged data compressing process that may be configured to transform input data to reference entries for a high-speed retrieval system. Some techniques of the present disclosure may adapt traditional models to a cohesive framework for more efficiently handling portions of the data matching process.

In some embodiments, the computing system 101 may communicate with at least one of the client computing entities 102 using one or more communication networks. Examples of communication networks comprise any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate a code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., compression techniques, retrieval techniques, matching techniques) described herein. The external computing entities 108, for example, may comprise and/or be associated with one or more entities that may be configured to receive, transmit, store, manage, and/or facilitate datasets, such as various reference datasets, and/or the like. The external computing entities 108, for example, may comprise data sources that may provide such datasets, and/or the like to the predictive computing entity 106 which may leverage the datasets to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Predictive Computing Entity

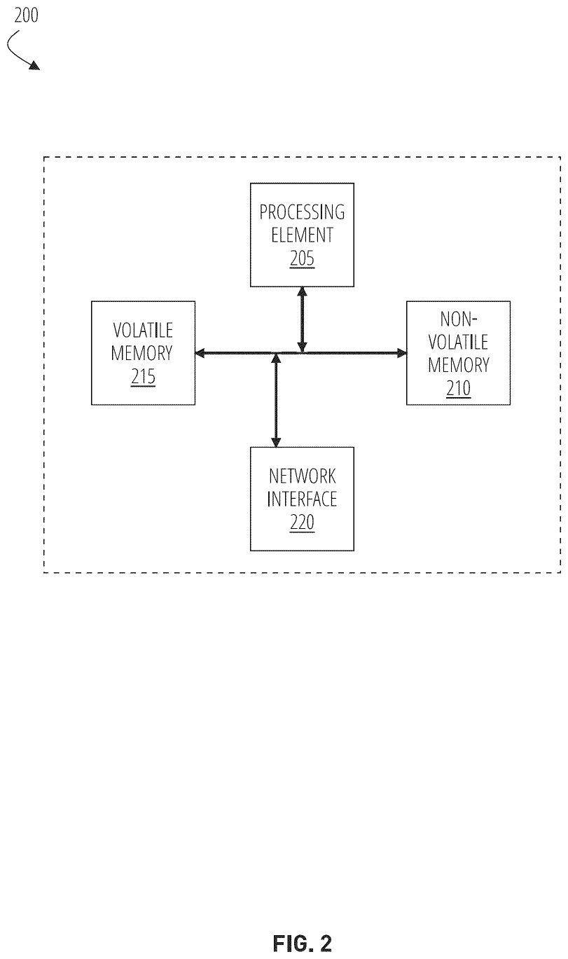

FIG. 2 depicts an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably) and/or volatile memory 215 (also referred to as volatile media, storage, memory storage, memory circuitry, and/or similar terms used herein interchangeably), as discussed above.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium including random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As will be recognized, the non-volatile memory 210 and/or the volatile memory 215 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (including volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

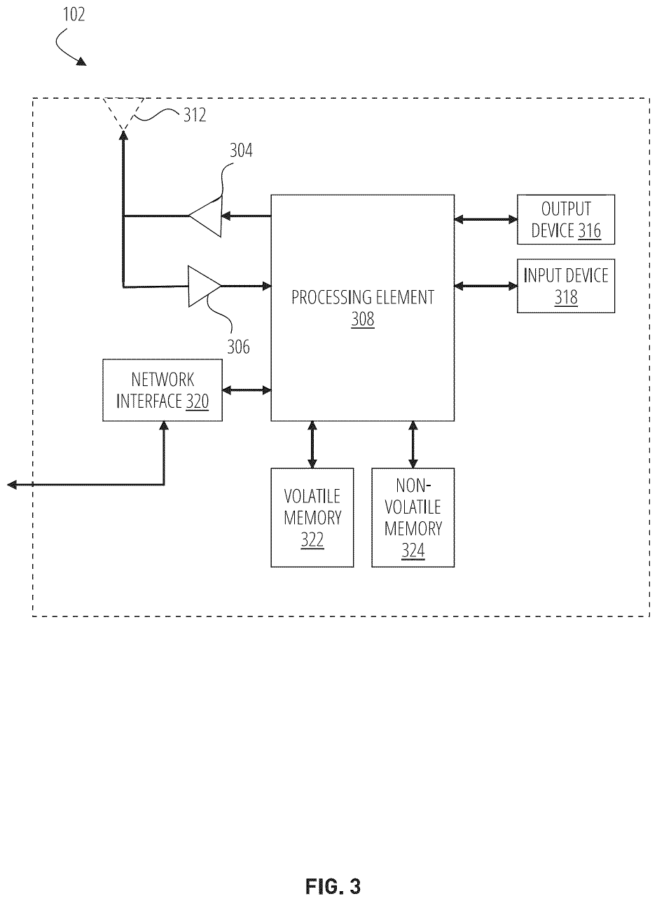

FIG. 3 depicts an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., including executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. Example System Operations

As indicated, various embodiments of the present disclosure make important technical contributions to computer functionality. In particular, systems and methods are disclosed herein that implement machine learning and data compression techniques to improve data retrieval, storage, and matching operations in high-dimensional computing environments. By doing so, the machine learning and data compression techniques of the present disclosure enable improved data storage and retrieval processes that, when executed on a computer, improves computer resource allocation. This, in turn, may improve the functionality of a computer with respect to various computing tasks, comprising data security, machine learning training, network communication, and the like.

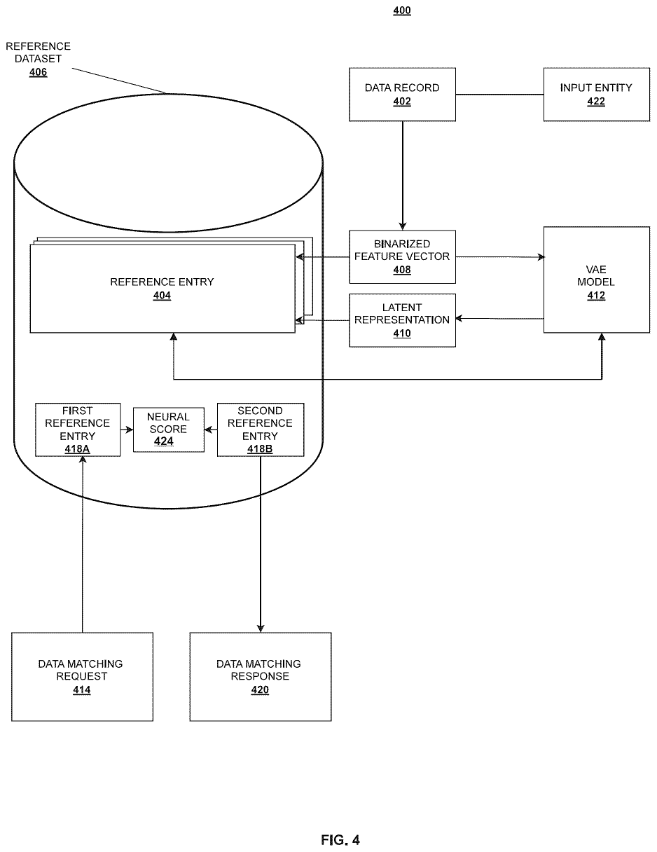

FIG. 4 depicts a dataflow diagram 400 of an example compressed data matching technique in accordance with some embodiments of the present disclosure. The compressed data matching technique may comprise a latent representation 410 based data matching process that is powered by a multi-staged data compression technique. By synthesizing the two processes, the compressed data matching technique improves data retrieval by transforming a high-dimensional feature space into a reference dataset 406 that combines high-dimensional feature vectors with low-dimensional counterparts. For example, the reference dataset 406 may comprise a plurality of reference entries that respectively comprise pairs of binarized feature vectors 408 and latent representations 410. As described herein, the binarized feature vectors 408 and latent representations 410 may be used to process data matching requests 414 at improved retrieval speed relative to traditional approaches. At the same time, the reference dataset 406 may store feature dense data within compressed data structures, reference entries, to decrease the memory footprint of the compressed data matching technique.

In some embodiments, a data record 402 is received for an input entity 422. In addition, or alternatively, a data entry may be received for a reference entry 404 that corresponds to a previously processed input entity 422. An input entity 422 may comprise a data entity that is the target of a data matching technique. An input entity 422, for example, may be an individual, object, or concept for which data is collected and analyzed. An input entity 422 may depend on an information domain and/or data matching technique. For instance, in a computer security domain, the input entity 422 may comprise a computer program in an application selection process. As other examples, in a healthcare domain, the input entity 422 may comprise a patient in a clinical trial selection process. In a business domain, an input entity 422 may comprise a company and/or product being analyzed for market comparisons and/or financial predictions, and/or the like. By way of example, in the context of healthcare and clinical trials, an input entity 422 may represent an individual patient whose data is being analyzed or compared against a larger dataset of reference patients.

In any domain, an input entity 422 may be digitally represented by an entity identifier. The entity identifier, for example, may comprise a unique string of characters, numerals, symbols, and/or combinations thereof that uniquely identify the input entity 422. In some examples, the entity identifier (e.g., the input entity 422) may be associated with one or more data records 420 that describe features for the input entity 422. The data records 420 may be stored in various formats, such as relational database tables, document-oriented databases, graph databases, and/or the like, and/or may be received from one or more different external sources. The data associated with an input entity 422 may comprise structured data (e.g., demographic information, diagnostic codes), unstructured data (e.g., clinical notes, medical images), and/or the like.

As described herein, the data matching techniques of the present disclosure may employ a combination of machine learning, statistical, and data mining models to extract features from the data associated with an input entity 422. By doing so, the data matching techniques of the present disclosure may extract dense features (e.g., binarized feature vectors 408) for up to each of a set of input entities within an information domain. These features may be compressed, using compression techniques of the present disclosure, to generate latent representations 410 that may be stored in a reference dataset 406 for a set of reference entities to improve the retrieval and processing speeds relative traditional data matching approaches, while reducing the memory footprint of a set of reference entities associated with an information domain.

In some embodiments, a data record 402 comprises a data construct that describes data associated with an input entity 422 (e.g., an unprocessed entity) or a reference entity (e.g., a processed entity). A data record 402, for example, may describe a set of data features that provide context and details about an entity's history, characteristics, or interactions within a specific domain. For example, in the healthcare context, a data record 402 may comprise an electronic health record (EHR) or a portion thereof, such as a new medical claim or clinical visit record. Other examples may comprise a financial statement for a business, a debugging or malware detection report for a software application, and/or the like.

A data record 402 may be stored in a structured, semi-structured, and/or natural language format within one or more document datastores and/or other data storage mechanisms. Each record may contain various types of information, comprising numerical data, text, dates, categorical variables, images, and/or the like. The various types of information may be transformed to binarized features to represent an entity using a dense feature vector. By way of example, in the context of electronic health records, a data record 402 may comprise patient demographics, medical history, diagnoses, treatments, medications, lab results, and/or other clinical information that may be serve as basis for a set of features of an input entity 422. In some examples, data records 420 may be received from a plurality of different data sources. Each data record 402 may be stored in a document datastore (e.g., relational databases, document-oriented databases) optimized for efficient storage and retrieval. In the case of EHRs, a data record 402 may be defined by standardized format, such as HL7 (Health Level Seven), FHIR (Fast Healthcare Interoperability Resources), and/or the like, to enable interoperability and consistent representation of medical data across disparate healthcare systems.

In some examples, upon reception of a data record 402, the data matching techniques of the present disclosure may pre-process (e.g., data clean, normalize, feature extract, and/or the like) to prepare the information represented by the data record 402 for use with one or more machine learning models of the present disclosure. By way of example, a data record 402 for an input entity 422 may be processed to extract a set of features that may be aggregated to generate a binarized feature vector 408 for use in training a machine learning model (e.g., an encoder-decoder machine learned model 412) used in the data matching process.

In some embodiments, a data record 402 comprises a plurality of data entries for an input entity 422. A data entry may comprise a single unit of information (e.g., a medical claim of healthcare record, one of a series of performance report for a malware record) for an associated with an input entity 422 (e.g., an unprocessed entity) or a reference entity (e.g., a processed entity). A data entry, for example, may represent a discrete piece of data that provides specific information about an entity. For example, a data entry may comprise a component (e.g., a single medical claim, a clinical visit record) of a data record 402 (e.g., a healthcare record). In addition, or alternatively, the data entry may comprise new data (e.g., a new clinical record, a new performance report) that may be added to a data record 402 (e.g., a healthcare record, a malware record).

In some examples, a data entry (e.g., of a data record 402 or added to a data record 402) may reflect one or more features of an entity. For example, in a healthcare domain, a data entry may comprise one or more data points, such as a diagnosis code, a lab result, and/or the like, that may be reflective of a healthcare feature (e.g., the presence or absence of medical code). In some examples, a data entry may comprise metadata, such as timestamps, identifiers, categorizations, and/or the like, that provide context for one or more features. By way of example, each data entry may correspond to a timestamp that identifies a timing of a reception or a recordation of the data entry and/or one or more features therein.

In some examples, a plurality of data entries from a data record 402 may be processed to extract (e.g., by applying natural language processing (NLP) technique) a set of features for an entity. A feature, for example, may correspond to one or more terms, values, and/or other representations within a data record 402. A feature may be extracted from the data record 402 by detecting the one or more terms, values, and/or other representations corresponding to the feature. By way of example, the data record 402 may be processed by one or more NLP techniques configured to detect and extract a set of one or more terms, values, and/or other representations corresponding to up to each of a set of defined features for a particular domain.

In some examples, the set of features may be extracted based on the timestamps of the data entries. For instance, the set of features may be extracted from one or more of data entries associated with a timestamp that is within a threshold time period (e.g., a life of the entity, a year, one or more months, weeks, days). Up to each of the set of features may identify a granular data point or characterization of a set of data points for maintaining an up-to-date and accurate representation of an entity's characteristics within a reference dataset 406. In this respect, the set of features may depend on the information domain and/or the measured characteristics therein. By way of example, using a healthcare use case for illustration, the set of features may indicate a presence and/or an absence of a code (e.g., an International Classification of Diseases (ICD) code, a Current Procedural Terminology (CPT)) from a medical coding system. In such a case, the set of features may indicate a presence of a subset of medical codes from a defined set of medical codes within a medical coding system.

As described herein, the set of extracted features may be aggregated to generate a binarized feature vector 408 for the entity that may be used to represent the entity within a reference dataset 406. In some examples, the binarized feature vector 408 may form one portion of a reference entry 404 for the entity.

In some embodiments, a reference entry 404 is generated and/or updated for an input entity 422 based on a data record 402 and/or data entry. For example, a reference entry 404 may be generated for an input entity 422 based on an input binarized feature vector 408 for the input entity 422 and an input latent representation 410 for the input binarized feature vector 408. As described herein, in some examples, the reference entry 404 is generated using an encoder portion of an encoder-decoder machine learned model 412.

In some embodiments, the reference entry 404 is a single unit within a reference dataset 406 that represents a specific entity. A reference entry 404, for example, may comprise a plurality of linked components that each individually provide comprehensive representations of the entity at different levels of dimensionality. By way of example, a reference entry 404 may comprise one or more of an entity identifier, a binarized feature vector 408, and/or a latent representation 410 of the binarized feature vector 408.

The entity identifier, for example, may comprise a unique identifier that corresponds to an entity and distinguishes the reference entry 404 from others in the dataset. For example, in a healthcare context, an entity identifier may comprise a patient identifier, a unique medical record number, and/or the like. In some examples, the entity identifier may be leveraged as a primary key in the reference dataset 406 to enable efficient indexing and retrieval of specific entries.

In some examples, a reference entry 404 may comprise an entity identifier that is linked (e.g., by a pointer, reference, storage location) to a binarized feature vector 408 and/or a latent representation 410 of the binarized feature vector 408. For instance, the binarized feature vector 408 may comprise a high-dimensional representation of the characteristics and/or attributes of the entity corresponding to the linked entity identifier. The latent representation 410 may comprise a lower-dimensional encoding of the binarized feature vector 408 that captures the essential characteristics of the entity in a compressed form for facilitating efficient comparison and matching operations. The combination of the high-dimensional binarized feature vector 408 and its lower-dimensional latent representation 410 may enable both detailed comparisons and efficient similarity computations, enabling the system to perform accurate and scalable data matching, as described herein.

In some embodiments, the reference dataset 406 is a data structure that stores a set of reference entries that respectively represent a set of reference entities. The reference dataset 406, for example, may comprise one or more databases, data warehouses, datastores, and/or the like that store a set of reference entries for access by one or more data matching techniques of the present disclosure. By way of example, the reference dataset 406 may comprise one or more relational databases (e.g., PostgreSQL, MySQL), NoSQL databases (e.g., MongoDB, Apache Cassandra), specialized big data platforms (e.g., Apache Hadoop, Apache Spark), linked lists, graph data structures, and/or the like.

The reference dataset 406 may comprise a set of reference entries that respectively represent a current and/or historical state of a set of entities. For instance, the reference dataset 406 may comprise a set of reference entries that is respectively generated based on a plurality of historical data entries (e.g., data entries within a reference time period) within up to each of a plurality of data records 420 respectively corresponding to the plurality of reference entries. In addition, or alternatively, a first reference entry 418A of the set of reference entries may be dynamically updated based on an input data entry that is received for the first reference entry over time. This may be repeated for up to all of the plurality of reference entries. For example, in response to an input data entry that corresponds to a reference entry 404, the reference entry 404 may be updated (e.g., by modifying a binarized feature vector 408 and/or generating a new latent representation 410 using the modified binarized feature vector) to reflect one or more features extracted from the input data entry. In this manner, a reference dataset 406 may maintain an up-to-date representation of a set of entities to improve the performance of downstream training operations and/or the accuracy of downstream data matching processes.

In some embodiments, a set of features is extracted from the data record 402 to generate a binarized feature vector 408 for the input entity 422. In addition, or alternatively, one or more new features may be extracted (e.g., using NLP techniques) from a data entry that corresponds to a previously processed input entity 422. In such a case, the binarized feature vector 408 of the reference entry 404 corresponding to the previously processed input entity 422 may be updated based on the new feature.

By way of example, the binarized feature vector 408 may comprise a set of binary values that respectively correspond to a defined set of features. A binary value of the set of binary values may identify a presence and/or an absence of a feature from the defined set of features within the data record. The binarized feature vector 408 may include a set of binary values that respectively correspond to a feature index. The feature index, for example, may define a sequence of feature positions that identifies an indexed position within the binarized feature vector 408 for up to each of a set of defined features within a particular domain. To update a binary feature vector 408, a feature index position within the binarized feature vector 408 may be determined that corresponds to a new feature and the binary value at the feature index position may be modified (e.g., from 0 to 1) to indicate a presence of the new feature for the entity.

More particularly, in some embodiments, the binarized feature vector 408 is a high-dimensional vector representation of an entity's characteristics. The binarized feature vector 408, for example, may be defined by a plurality of dimensions, in which each dimension corresponds to a specific feature or attribute, and the values of each dimension are binary (0 or 1) indicating the presence and/or absence of the specific feature or attribute. For instance, the binarized feature vector 408 may comprise a set of binary values (0 or 1) respectively indicating the presence and/or absence of a set of defined features. The set of defined feature may be domain specific. By way of example, in a healthcare domain, the defined features may correspond to a set of medical codes (e.g., ICD codes, CPT codes) and the binarized feature vector 408 may indicate a presence and/or an absence of a particular medical code within a particular time period of a patient's medical history and/or a quantity associated with a medical, biological, and/or biochemical test. In examples where the feature vector is a binary feature vector, such a quantity may be indicated by a set of bits of the vector and/or may be quantized to scale the quantity based on the number of bits allocated to indicating that quantity.

In some examples, a binarized feature vector 408 may comprise a sparse vector, bit array, and/or any other representation of a set of binary values. For instance, in some information domains, a majority of entities may be associated with a small subset of defined features (e.g., patients are likely to have only a small number of thousands of possible ICD codes within a healthcare domain). By leveraging a sparse vector, the small subset of defined features may be accurately represented in a memory efficiency manner.

A binarized feature vector 408 may be generated by extracting a set of features from one or more data entries associated with an entity. A feature, for example, may be generated using one or more feature engineering techniques (e.g., image recognition, natural language processing) configured to map raw data (e.g., images, text, etc.) to a defined feature (e.g., ICD codes). In some examples, each feature may correspond to a position or range of positions (e.g., to indicate a quantity greater than 1) within a binarized feature vector 408. In response to mapping raw data from a data entry to a defined feature, the position within the binarized feature vector 408 that corresponds to the defined feature may be updated from “0” to a “1” indicating the presence of the feature within at least a portion of the entity's data record 402. In this manner, a raw data record 402 may be transformed to a dense feature vector to ensure consistent representation across different entities and lower the memory requirements of representing the entities.

In some embodiments, the binarized feature vector 408 may be input to the encoder portion of the encoder-decoder machine learned model 412 to generate the latent representation 410 of the binarized feature vector 408. In addition, or alternatively, an updated binarized feature vector 408 corresponding to a previously processed input entity 422 may be input to the encoder portion of the encoder-decoder machine learned model 412 to regenerate the latent representation 410 of the updated binarized feature vector 408.

In some embodiments, a latent representation 410 is a lower-dimensional feature vector derived from a higher-dimensional binarized feature vector 408. A latent representation 410, for example, may comprise a compact and informative encoding of binarized feature vector 408 that captures the semantic relationships between a set of features expressed by the binarized feature vector 408. An informativeness of a latent representation 410, for example, may be measured by an ability to reconstruct a binarized feature vector 408 from a latent representation 410, where a more informative latent representation 410 enables a more accurate reconstruction of the binarized feature vector 408. By way of example, the latent representation 410 may comprise a dense vector of floating-point numbers, and/or the like that may be used to reconstruct a binarized feature vector 408. For instance, the latent representation 410 may be generated by inputting the binarized feature vector 408 through an encoder portion of a trained machine-learned model, such as a VAE autoencoder or an encoder that has been trained in tandem with a decoder model (i.e., an encoder-decoder model or encoder-only model trained and/or fine-tuned in tandem with a decoder-only model).

In some examples, the binarized feature vector 408 may have a first dimension that is higher than a second dimension of the latent representation 410. For instance, the dimensionality of the latent representation 410 may be lower (e.g., by orders of magnitude) than the binarized feature vector 408. This reduction in dimensionality may improve both the accuracy and memory usage of a data matching process. For example, by reducing the dimensionality of the binarized feature vector 408, the latent representation 410 may remove and/or otherwise reduce the impact of noisy features that traditionally reduce the accuracy of data matching processes. In addition to improved accuracy, by working in the lower-dimensional latent space, the data matching techniques of the present disclosure may improve the retrieval speed of data matching operations by enabling rapid comparisons between entities without the computational burden associated with high-dimensional data. Ultimately, this enables a scalable matching processes, even when dealing with large reference datasets 406.

In some embodiments, the encoder-decoder machine learned model 412 is a trained machine learning model configured to compress and then reconstruct an input. An encoder-decoder machine learned model 412, for example, may comprise a generative machine learning model (e.g., a VAE model) designed to learn compact, lower-dimensional representations (e.g., latent representations 410) of high-dimensional data (e.g., binarized feature vectors 408) that may be used to reconstruct the high-dimensional data. By way of example, an encoder-decoder machine learned model 412 may comprise an encoder portion configured to compress the high-dimensional data (e.g., by determining a latent representation using the feature vector) and a decoder portion trained to reconstruct, as a prediction, the high-dimensional data from the lower-dimensional representation that is provided as input to the decoder portion. The encoder and decoder portions may be trained end-to-end to improve a reconstruction accuracy between the input high-dimensional data and the reconstructed high-dimensional data. For example, training the encoder and decoder may comprise generating, by the encoder, a latent representation 410 using a feature vector (e.g., a binarized feature vector 408); determining, by the decoder, an estimated reconstruction of the original feature vector (e.g., a binarized feature vector 408) using the latent representation 410; and determining a loss based at least in part on a difference between the estimated reconstruction and the original feature vector (e.g., a binarized feature vector 408). This loss may then be backpropagated through the encoder and decoder, which may comprise altering one or more parameters of the encoder and/or the decoder to reduce the loss according to a gradient descent algorithm (e.g., scheduled gradient descent, stochastic gradient descent (SGD), Adam, RMSprop). In some examples, loss may be an unsupervised loss determined using an evidence lower bound loss (ELBO) function, although any other loss function may be used, such as a Cauchy loss, Huber loss, L1, L2, and/or the like. This may allow the encoder to learn meaningfully differentiated latent representations (e.g., embeddings/encodings) such that the decoder is capable of accurately reproducing the original feature vector provided as input to the encoder due to this trained differentiation.

In some embodiments, the unsupervised machine learning model loss may be used as a performance metric used to quantify the performance of the encoder-decoder machine learned model 412. The unsupervised machine learning model loss, for example, may comprise a performance metric that combines a reconstruction loss and/or a regularization term. For instance, the loss may combine a reconstruction loss (e.g., mean squared error, binary cross-entropy, Cauchy loss determined based at least in part on a difference between an estimated reconstruction output by the decoder and the original input to the encoder) with a regularization term that encourages the latent space distribution to approximate a standard normal distribution (e.g., Kullback-Leibler (KL) divergence). The regularization term may measure a distribution of a latent space, such as a KL divergence that encourages the latent space distribution to approximate a standard normal distribution. In some examples, the unsupervised machine learning model loss may comprise a negative Evidence Lower Bound (ELBO) that combines the reconstruction loss and the KL divergence term, providing a lower bound on the log-likelihood of the data under the model.

In some examples, the decoder portion of the encoder-decoder machine learned model 412 may be discarded after training, output of the encoder to the decoder may be suppressed, and/or the like, as the decoder may function primarily to train the encoder via the unsupervised method described above. Although, in additional or alternate examples, the decoder portion may be stored in association with the encoder portion. By way of example, the decoder portion may be used to track drift in the encoder's ability to generate meaningfully differentiated embeddings (e.g., due to changes in feature patterns, the addition or removal of features within a particular domain) For example, the decoder portion may reconstruct a binarized feature vector 408, as described above, during inference. The reconstruction loss may be measures over time windows to identify data drift over time based on difference in reconstruction loss across the time windows. In the event of an average reconstruction loss difference and/or a trend in the average reconstruction loss difference meets or exceeds a threshold, a batch of the data last put through the encoder may be used to fine-tune the encoder-decoder machine learned model 412.

In this way, at least a portion of the reference dataset 406 (e.g., binarized feature vectors 408) may be used as training data for a machine learning model, such as the encoder-decoder machine learned model 412, to train the machine learning model. Then, incoming portions of the reference dataset 406 (e.g., new binarized feature vectors) may be used to measure date drift and/or continuously retrain the machine learning model, such as the encoder-decoder machine learned model 412.

In some embodiments, the reference entry 404 is stored in the reference dataset 406. In some embodiments, the reference dataset 406 is generated through a multi-staged data compression technique. The multi-staged data compression technique, for example, may comprise a first, transformation stage, a second, training stage, and a third, compression stage.

In some embodiments, during the first transformation stage of the multi-staged data compression technique, a set of binarized feature vectors 408 may be generated that respectively correspond to a set of input entities. The set of binarized feature vectors 408, for example, may be generated by transforming a set of data records 420 respectively corresponding to the set of binarized feature vectors 408 using some of the techniques of the present disclosure.

In some embodiments, during the second stage of the multi-staged data compression technique, the trained encoder-decoder machine-learned model 412 may generate a set of latent representations using a set of binarized feature vectors 408. For example, the encoder-decoder machine-learned model 412 may comprise an encoder portion that generates a first latent representation using a first binarized feature vector. After the model is trained, lower-dimensional representations (e.g., latent representations 410) may be stored within the reference dataset 406 to improve the efficiency of downstream data matching processes. In this manner, the reference dataset 406 may be leveraged to train an encoder-decoder machine-learned model 412 that may then augment the reference dataset 406 with lower-dimensional representations to ultimately improve the timing, efficiency, and cost of data matching operations, while reducing the memory requirements of the reference dataset 406.

The encoder-decoder machine-learned model 412 may comprise an encoder portion and/or a decoder portion. As discussed above, in some examples the decoder portion may be used for training and/or tracking encoder performance. In some examples, the encoder portion may comprise a first (encoder) neural network and the decoder portion may comprise a second (decoder) neural network. These networks may be differentiated in that the encoder may comprise a greater number of input nodes than the input nodes associated with the decoder, but a lesser number of output nodes than the output nodes associated with the decoder. In an example, where the decoder is trained to reconstruct the input to the encoder, the number of input nodes associated with receiving the input at the encoder may be equal to the number of output nodes associated with the reconstruction output by the decoder. The encoder and/or decoder neural networks may be configured in one or more different architectures, such as one or more multilayer perceptrons (MLPs), convolutional neural networks (CNNs), Kolmogorov-Arnold networks (KANs), and/or the like. The encoder neural network may receive a high-dimensional data input (e.g., a binarized feature vector 408) and use the high-dimensional data input, as a function of trained parameters of the encoder architecture, to generate a probability distribution in a lower-dimensional latent space to generate a latent representation 410 of the high-dimensional data input (e.g., a binarized feature vector 408). The decoder neural network may sample from or otherwise process the latent distribution as a function of trained parameters of the decoder architecture, to reconstruct the original high-dimensional data input (e.g., a binarized feature vector 408). In some examples, the encoder neural network outputs parameter(s) (e.g., mean, variance) for one or more probability distributions in the latent space (e.g., a multivariate Gaussian distribution). The decoder neural network may sample the distribution according to its trained parameters to generate an estimated reconstruction of the original input.

In some examples, in response to determining a performance metric is less than a performance threshold, the training may be stopped. The performance threshold may be based on one or more metrics and/or combinations of metrics, depending on the specific requirements of the application. For example, the performance threshold may comprise a threshold average, median, or raw reconstruction loss, threshold KL divergence, and/or a threshold ELBO determined for the last n pairs of training data (e.g., feature vectors and estimated reconstructions thereof), where n is a positive integer, although any other convergence criterion(a) may be used. In response to the performance threshold being determined to be below a threshold performance metric, parameter(s) of the encoder-decoder machine-learned model 412 may be frozen and the machine-learned model 412 may be output or otherwise instantiated for use in a data matching process. By doing so, the performance threshold may ensure an overall reliability and effectiveness of the data matching processes that leverage latent representations 410 to replace higher dimensional feature vectors, such as the binarized feature vectors 408 of the present disclosure.

In some embodiments, during the third, compression stage of the multi-staged data compression technique, the encoder may generate a set of latent representations 410 using a set of binarized feature vectors 408. For example, the encoder may generate a first latent representation for a first binarized feature vector of the set of binarized feature vectors 408 and store the first latent representation with the first binarized feature vector within a first reference entry 418A. This may be completed for up to each binarized feature vector of the set of binarized feature vectors 408 to generate a set of reference entries. In this manner, the set of binarized feature vectors 408 and/or the set of latent representations 410 may be stored within the reference dataset 406 as a set of reference entries.

In some embodiments, a data matching request 414 is received that identifies a first reference entry 418A from the reference dataset 406. The first reference entry 418A, for example, may comprise a binarized feature vector 408 of a first dimension and/or a latent representation 410 of the binarized feature vector 408 of a second dimension that is lower than the first dimension, as described herein. In some examples, the first reference entry 418A may be identified based on the binarized feature vector 408. In some examples, the latent representation 410 of the binarized feature vector 408 may be generated by the encoder portion of the encoder-decoder machine learned model 412 that is previously trained using the reference dataset 406.

In some embodiments, the data matching request 414 may comprise a query, instruction, and/or request that requests an identification of one or more reference entries that match search criteria. For instance, a data matching request 414 may comprise an application programming interface (API) call that comprises one or more request parameters. In some examples, a data matching request 414 (and/or request parameters thereof) may identify a first reference entry 418A from the reference dataset 406 and aims to find second reference entries that are similar or related to the first reference entry 418A. For instance, the data matching request 414 may comprise an entity identifier corresponding to the first reference entry 418A. In addition, or alternatively, the data matching request 414 may comprise one or more matching criteria that describe entity characteristics. By way of example, a data matching request 414 may identify one or more defined features that correspond to a binarized feature vector 408 of a first reference entry 418A. In some examples, the data matching request 414 may comprise one or more contextual matching instructions, such as a threshold matching score (e.g., a similarity threshold between a first reference entry 418A and second, output reference entries), minimum and/or maximum number matching outputs (e.g., instructions on how many second reference entries to return), and/or the like.

In some examples, the matching criteria may identify a set of input features that may or may not correspond (e.g., exactly and/or partially match a binarized feature vector 408 stored within one of the set of reference entries) to a reference entry that exists within the reference dataset 406. If the set of input features correspond an existing reference entry, the first reference entry 418A is identified as the existing reference entry. In addition, or alternatively, if the set of input features do not correspond an existing reference entry, the first reference entry 418A may be generated from the set of input features. For example, the encoder portion of the encoder-decoder machine learned model 412 may be applied to a new binarized feature vector for the set of input features to generate a new latent representation for the data matching request 414 and the new binarized feature vector and/or new latent representation may be used as the first reference entry 418A.

In some embodiments, a matching score 424 is determined between a first latent representation of the first reference entry 418A and a second latent representation of a second reference entry 418B within the reference dataset 406. For example, a matching score 424 may be determined for the second reference entry 418B based on determining a quantitative measurement of similarity between the first latent representation and a second latent representation associated with/generated for the second reference entry 418B. In some examples, the matching score 424 may be a cosine distance, a Euclidean distance, Mahalanobis distance, and/or the like between the first latent representation associated with/generated for the first reference entry 418A and the second latent representation associated with/generated for the second reference entry 418B in the latent space. In some embodiments, the techniques discussed herein may indicate that a reference entry is a match to the request based at least in part on a matching score determined between the respective latent representations generated for the entries meeting or exceeding a threshold matching score. A threshold matching score, for example, may be leveraged as a boundary for accepting or rejecting potential matches in a data matching process. For example, if a matching score 424 meets or exceeds the threshold matching score, the second reference entry 418B may be output as a match to a first reference entry 418A (e.g., if all other contextual matching instructions are satisfied). In some examples, a threshold matching score may be identified by a data matching request 414. In addition, or alternatively, the threshold matching score may comprise a predefined and/or tunable parameter that may be adjusted based on the specific requirements of the matching task. For instance, the threshold matching score may be set manually by domain experts and/or determined automatically based on feedback identifying an accuracy of the data matching outputs. By way of example, the threshold matching score may be adaptively increased to increase a similarity of the data matching outputs at the cost of an amount of the data matching outputs or decreased to increase an amount of data matching outputs at the cost of similarity. In some examples, a data matching response may output the top p matching entries, as ranked by matching score, where p is a positive integer that may be predefined, dependent upon the total number of entries, and/or indicated in the request.

In some embodiments, a data matching response 420 is output in response to a data matching request 414. For instance, the second reference entry 418B may be output in response to the data matching request 414 based on the matching score 424. The second reference entry 418B, for example, may be output in response to the data matching request 414 in response to determining that the matching score 424 meets or exceeds a threshold matching score. In some examples, the threshold matching score may be defined by the data matching request 414.

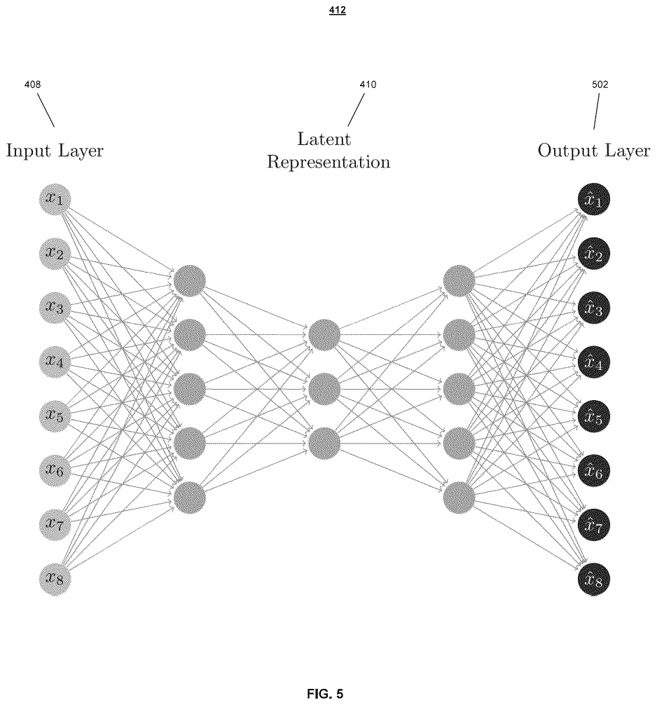

FIG. 5 depicts an operational example of an encoder-decoder machine learned model 412 in accordance with some embodiments of the present disclosure. As shown in the operational example, the encoder-decoder machine learned model 412 may receive a binarized feature vector 408 at an input layer (e.g., by inputting the binarized feature vector 408 into up to each of the nodes depicted as the input layer) with a plurality of features. An encoder portion of the encoder-decoder machine learned model 412 is configured to reduce the dimensionality of the binarized input vector 408 to generate a latent representation 410 with less dimensions than the binarized input vector 408. The latent representation 410 may be input to a decoder portion of the VAE model 412 to generate a reconstructed binarized feature vector 502. By training the VAE model 412, end-to-end, to generate a latent representation 410 and then decode the latent representation 410 to generate a reconstructed binarized feature vector 502 that matches the original binarized feature vector 408, the VAE model 412 may learn to detect and weigh features from the binarized feature vector 408 to generate latent representation 410 that adequately differentiate a portion of the features such that the decoder is able to reconstruct the original input from the latent representation (e.g., based on only a portion of the original input), meaning that the encoder is sufficiently trained to remove or deemphasize less important features of the input data while improving similarity comparisons by emphasizing more important features within the binarized feature vector 408 and/or collectively characterizing multiple features as a single feature of the latent representation.

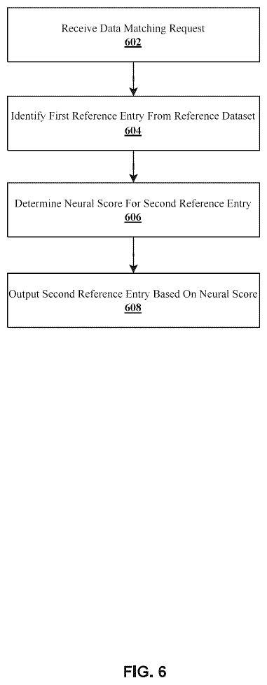

FIG. 6 depicts a flowchart diagram of an example data matching process 600 in accordance with some embodiments of the present disclosure. The flowchart diagram depicts a compressed data matching technique that leverages latent representations of binarized feature vectors to improve matching accuracy at reduced retrieval speeds. The process 600 may be implemented by one or more computing devices, entities, and/or systems described herein. For example, via the various steps/operations of the process 600, the computing system 101 may leverage the data matching techniques to effectively transform complex, multi-dimensional vectors of any size into dense latent representations that may be used to facilitate improved data matching operations. By doing so, the process 600 improve computer functionality by decreasing retrieval speeds and memory requirements, while improving accuracy relative to traditional data matching approaches.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 comprises, at operation 602, receiving a data request. For example, the computing system 101 may receive a request that identifies a first reference entry from a reference dataset. In some examples, the first reference entry comprises a binarized feature vector of a first dimension and a latent representation of the binarized feature vector of a second dimension that is lower than the first dimension. The first reference entry may be identified based on the binarized feature vector. In some examples, the latent representation of the binarized feature vector may be generated by an encoder portion of an encoder-decoder machine learned model that is previously trained using the reference dataset.

In some embodiments, the process 600 comprises, at operation 604, identifying a first reference entry from a reference dataset. For example, the computing system 101 may identify the first reference entry from the reference dataset based on the request. In addition, or alternatively, the computing system 101 may generate a new first reference entry based on the request, as described herein.

In some embodiments, the process 600 comprises, at operation 606, determining a matching score for a second reference entry. For example, the computing system 101 may determine a matching score for a second reference entry from the reference dataset based on a difference between the latent representation and a second latent representation generated by the encoder for the second reference entry. In some examples, the matching score is a cosine distance similarity measure between the latent representation of the first reference entry and another latent representation of the second reference entry.

In some embodiments, the process 600 comprises, at operation 608, outputting a second reference entry based on the matching score. For example, the computing system 101 may output, based on the matching score meeting or exceeding a threshold score, the second reference entry in response to the request. In some examples, the computing system 101 may output the second reference entry in response to a determination that the matching score meets or exceeds a threshold matching score. In some examples, the threshold matching score may be defined by the data matching request.

Some techniques of the present disclosure enable the generation of action outputs that may be performed to initiate one or more real world actions to achieve real-world effects. The techniques of the present disclosure may be used, applied, and/or otherwise leveraged to extract reference entries from a reference entry responsive to data matching requests. In some examples, the extracted reference entries may trigger action outputs (e.g., through control instructions) to automate computer performance actions, clinical actions, and/or the like. By way of example, in a healthcare context, the action outputs may trigger a pharmaceutical response (e.g., drug delivery, appointment reminder) responsive to a data matching request. By way of example, the pharmaceutical response may include a medication renewal for a second reference entry, a grouping of the second reference entry in an observed cohort, and/or the like. In some examples, the action outputs may control various aspects of a client device, such as the display, transmission, and/or the like of data reflective of an alert, and/or the like. The alert may be automatically communicated to a user and/or may be used to initiate a security protocol (e.g., locking a computer), a robotic action (e.g., performing an automated screening process), and/or the like.

In some examples, the computing tasks may comprise actions that may be based on an information domain. An information domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

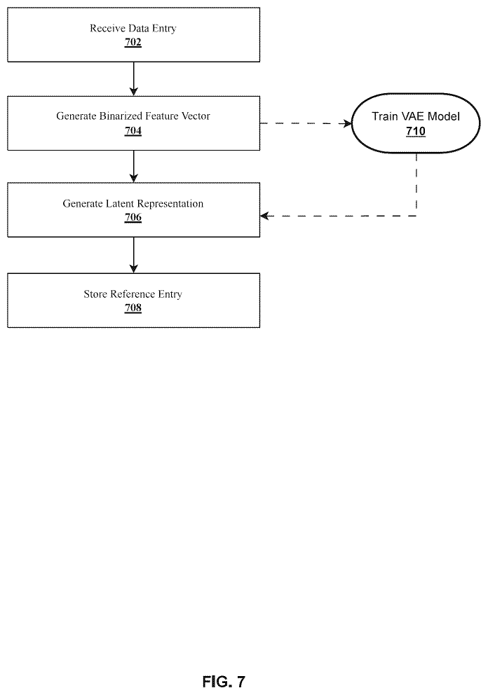

FIG. 7 is a flowchart diagram of an example, multi-stage data compression process 700 in accordance with some embodiments of the present disclosure. The flowchart diagram depicts a multi-stage data compression technique that transforms feature dense input data into latent representations that may replace the feature dense input data for storage and downstream processes. The process 700 may be implemented by one or more computing devices, entities, and/or systems described herein. For example, via the various steps/operations of the process 700, the computing system 101 may leverage a multi-stage data compression technique to reduce memory requirements downstream data matching and query processes, while improving performance. By doing so, the process 700 addresses several technical challenges of traditional data matching approached by enabling the creation of a reference dataset that requires less memory resources and may be dynamically updated to accurately represent a current state of an environment.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 comprises, at operation 702, receiving a data record and/or a data entry thereof that is associated with an entity. For example, the computing system 101 may receive the data record and/or a data entry thereof for an input entity. A data entry, for example, may correspond to a reference entry within a reference dataset. A data record may correspond to an input entity that is not yet associated with a reference entry.

In some embodiments, the process 700 comprises, at operation 704, generating a binarized feature vector. For example, the computing system 101 may generate, during a first stage, a first binarized feature vector indicating features of an input entity. In some examples, the computing system 101 may extract a set of features from a data record to generate an input binarized feature vector for an input entity. In addition, or alternatively, in a first stage of a data modification process, the computing system 101 may extract a new feature from a data entry for a binarized feature vector corresponding to a previously generated reference entry. For example, the computing system may extract a new feature from the data entry that is absent from the set of features from the data record. In some examples, the computing system 101 may update the binarized feature vector based on the new feature. By way of example, the binarized feature vector may comprise a set of binary values that respectively correspond to a defined set of features and a binary value of the set of binary values may identify a presence and/or an absence of a feature from the defined set of features within the data record. The computing system 101 may determine a feature index position within the binarized feature vector that corresponds to the new feature and modify a binary value at the feature index position to indicate a presence of the new feature for the entity.

In some embodiments, the process 700 comprises accessing a trained encoder-decoder machine-learned model (e.g., at least an encoder) to compress a binarized feature vector into a latent representation. In some examples, the process 700 may proceed to operation 706, where the trained encoder-decoder machine learned model is used to generate and/or regenerate a plurality of latent representations. In addition, or alternatively, the process 700 may comprise operation 710, where the encoder-decoder machine learned model is trained using a plurality of binarized feature vectors from a reference dataset. The encoder-decoder machine learned model, for example, may include a VAE model.

In some embodiments, the process 700 comprises, at operation 710, training the machine-learned model. For example, train, during a second stage, the encoder-decoder machine-learned model using the first binarized feature vector. The machine-learned model, for example, may comprise an encoder neural network and a decoder neural network. The machine-learned model may train the encoder neural network and the decoder neural network end to end, via backpropagation of errors, to minimize or maximize an unsupervised machine learning model loss based on a plurality of binarized feature vectors of the reference dataset. In some examples, the unsupervised machine learning model loss is determined using an ELBO function. In some examples, a third stage may be triggered in response to the machine-learned model meeting or exceeding a performance threshold.

In some embodiments, the process 700 comprises, at operation 706, generating a latent representation for the binarized feature vector. For example, during a third stage, the computing system 101 may generate, using the encoder portion of the encoder-decoder machine-learned model, a first latent representation for the first binarized feature vector. In this manner, the computing system 101 may generate, using the encoder portion of the machine-learned model, a reference entry for an input entity based on the data record. By way of example, the computing system 101 may input an input binarized feature vector to the encoder portion of the machine-learned model to generate an input latent representation of the input binarized feature vector. In addition, or alternatively, the computing system 101 may regenerate, using the encoder portion of the encoder-decoder machine learning model, the latent representation of the binarized feature vector as an updated latent representation.

In some embodiments, the process 700 comprises, at operation 708, storing a reference entry. For example, the computing system 101 may generate a new reference entry based on an input binarized feature vector and the input latent representation. The computing system 101 may store the first binarized feature vector and the first latent representation within the reference dataset as a first reference entry. By way of example, the computing system 101 may store the plurality of binarized feature vectors and the plurality of latent representations within the reference dataset as a plurality of reference entries. In addition, or alternatively, the computing system 101 may update a reference entry based on a regenerated latent representation of an updated binarized feature vector for a previously processed reference entry.

### IV. Conclusion

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as comprising logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “comprising,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present), and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model comprising one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S. C. § 112(f) unless traditional means-plus-function language is expressly recited, such as “means for” or “step for” language being explicitly recited in the claim(s).

### V. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each operation may be performed by any one or combination of computing devices, entities, and/or systems described herein. For example, a computing system may comprise a single computing entity that is configured to perform all of the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising receiving, by one or more processors, a request that identifies a first reference entry from a reference dataset, wherein (i) the first reference entry comprises (a) a binarized feature vector of a first dimension and (b) a latent representation of the binarized feature vector of a second dimension that is lower than the first dimension, (ii) the first reference entry is identified based on the binarized feature vector, and (iii) the latent representation of the binarized feature vector is generated by an encoder portion of an encoder-decoder machine-learned model that is previously trained using the reference dataset; and determining, by the one or more processors, a matching score for a second reference entry from the reference dataset based on a difference between the latent representation and a second latent representation generated by the encoder for the second reference entry; and outputting, by the one or more processors and based on the matching score meeting or exceeding a threshold score, the second reference entry in response to the request.

Example 2. The computer-implemented method of example 1, wherein the reference dataset is generated by generating, during a first stage, a first binarized feature vector indicating features of an input entity; training, during a second stage, the encoder-decoder machine-learned model using the first binarized feature vector; generating, during a third stage and using the encoder portion of the encoder-decoder machine-learned model, a first latent representation for the first binarized feature vector; and storing the first binarized feature vector and the first latent representation within the reference dataset as a first reference entry.

Example 3. The computer-implemented method of any of the preceding examples, wherein the encoder-decoder machine learned model is a variational autoencoder (VAE) model.

Example 4. The computer-implemented method of any of the preceding examples, further comprising receiving a data record associated with an entity; extracting a set of features from the data record to generate the binarized feature vector for the entity; generating, by the encoder portion of the encoder-decoder machine learning model and based at least in part on the binarized feature vector, the latent representation; generating the reference entry based on the binarized feature vector and the latent representation; and storing the reference entry for the entity in the reference dataset.

Example 5. The computer-implemented method of example 4, wherein the binarized feature vector comprises a set of binary values that respectively correspond to a defined set of features and a binary value of the set of binary values identifies a presence or an absence of a feature from the defined set of features within the data record.

Example 6. The computer-implemented method of any of examples 4 through 5, further comprising receiving a data entry for the reference entry; extracting a new feature from the data entry that is absent from the set of features from the data record; updating the binarized feature vector based on the new feature; and regenerating, using the encoder portion of the encoder-decoder machine learning model, the latent representation of the binarized feature vector as an updated latent representation.

Example 7. The computer-implemented method of example 6, wherein updating the binarized feature vector comprises determining a feature index position within the binarized feature vector that corresponds to the new feature; and modifying a binary value at the feature index position to indicate a presence of the new feature for the entity.

Example 8. The computer-implemented method of any of the preceding examples, wherein the matching score is a cosine distance similarity measure between the latent representation of the first reference entry and another latent representation of the second reference entry.

Example 9. The computer-implemented method of example 8, wherein the threshold matching score is defined by the request.

Example 10. A system comprising one or more processors; and one or more memories storing processor-executable instructions that, when executed by the one or more processors, cause the one or more processors to perform operations comprising receiving a request that identifies a first reference entry from a reference dataset, wherein (i) the first reference entry comprises (a) a binarized feature vector of a first dimension and (b) a latent representation of the binarized feature vector of a second dimension that is lower than the first dimension, (ii) the first reference entry is identified based on the binarized feature vector, and (iii) the latent representation of the binarized feature vector is generated by an encoder portion of a variational autoencoder (VAE) model that is previously trained using the reference dataset; and determining a matching score for a second reference entry from the reference dataset based on a difference between the latent representation and a second latent representation generated by the encoder portion for the second reference entry; and outputting, based on the matching score meeting or exceeding a threshold score, the second reference entry in response to the request.

Example 11. The system of example 10, wherein generating the reference dataset comprises generating, during a first stage, a first binarized feature vector indicating features of an input entity; training, during a second stage, the encoder-decoder machine-learned model using the first binarized feature vector; generating, during a third stage and using the encoder portion of the encoder-decoder machine-learned model, a first latent representation for the first binarized feature vector; and storing the first binarized feature vector and the first latent representation within the reference dataset as a first reference entry.

Example 12. The system of any of examples 10 through 11, wherein the encoder-decoder machine learned model is a variational autoencoder (VAE) model.

Example 13. The system of any of examples 10 through 12, wherein the one or more operations further comprise receiving a data record associated with an entity; extracting a set of features from the data record to generate the binarized feature vector for the entity; generating, by the encoder portion of the encoder-decoder machine learning model and based at least in part on the binarized feature vector, the latent representation; generating the reference entry based on the binarized feature vector and the latent representation; and storing the reference entry for the entity in the reference dataset.

Example 14. The system of example 13, wherein the binarized feature vector comprises a set of binary values that respectively correspond to a defined set of features and a binary value of the set of binary values identifies a presence or an absence of a feature from the defined set of features within the data record.

Example 15. The system of any of examples 13 through 14, wherein the one or more operation further comprise receiving a data entry for the reference entry; extracting a new feature from the data entry that is absent from the set of features from the data record; updating the binarized feature vector based on the new feature; and regenerating, using the encoder portion of the VAE model, the latent representation of the binarized feature vector as an updated latent representation.

Example 16. The system of example 15, wherein updating the binarized feature vector comprises determining a feature index position within the binarized feature vector that corresponds to the new feature; and modifying a binary value at the feature index position to indicate a presence of the new feature for the entity.

Example 17. The system of any of examples 15 through 16, wherein the matching score is a cosine distance similarity measure between the latent representation of the first reference entry and another latent representation of the second reference entry.

Example 18. One or more non-transitory computer-readable storage media storing processor-executable instructions that, when executed by one or more processors, cause the one or more processors to perform operations comprising: receiving a request that identifies a first reference entry from a reference dataset, wherein (i) the first reference entry comprises (a) a binarized feature vector of a first dimension and (b) a latent representation of the binarized feature vector of a second dimension that is lower than the first dimension, (ii) the first reference entry is identified based on the binarized feature vector, and (iii) the latent representation of the binarized feature vector is generated by an encoder portion of a variational autoencoder (VAE) model that is previously trained using the reference dataset; and determining a matching score for a second reference entry from the reference dataset based on a difference between the latent representation and a second latent representation generated by the encoder portion for the second reference entry; and outputting, based on the matching score meeting or exceeding a threshold score, the second reference entry in response to the request.

Example 19. The one or more non-transitory computer-readable storage media of example 18, wherein the operations further comprise receiving a data record associated with an entity; extracting a set of features from the data record to generate the binarized feature vector for the entity; generating, by the encoder portion of the encoder-decoder machine learning model and based at least in part on the binarized feature vector, the latent representation; generating the reference entry based on the binarized feature vector and the latent representation; and storing the reference entry for the entity in the reference dataset.

Example 20. The one or more non-transitory computer-readable storage media of example 19, wherein the operations further comprise receiving a data entry for the reference entry; extracting a new feature from the data entry that is absent from the set of features from the data record; updating the binarized feature vector based on the new feature; and regenerating, using the encoder portion of the encoder-decoder machine learning model, the latent representation of the binarized feature vector as an updated latent representation.

Example 21. The computer-implemented method of example 1, wherein the method further comprises training the encoder-decoder machine learned model.

Example 22. The computer-implemented method of example 21, wherein the training is performed by the one or more processors.

Example 23. The computer-implemented method of example 21, wherein the one or more processors are comprised in a first computing entity; and the training is performed by one or more other processors comprised in a second computing entity.

Example 24. The computing system of example 10, wherein the one or more processors are further configured to train the encoder-decoder machine learned.

Example 25. The computing system of example 24, wherein the one or more processors are comprised in a first computing entity; and the encoder-decoder machine learned is trained by one or more other processors comprised in a second computing entity.

Example 26. The one or more non-transitory computer-readable storage media of example 17, wherein the instructions further cause the one or more processors to train the encoder-decoder machine learned.

Example 27. The one or more non-transitory computer-readable storage media of example 26, wherein the one or more processors are comprised in a first computing entity; and the encoder-decoder machine learned is trained by one or more other processors comprised in a second computing entity.

What is claimed is:

1. A computer-implemented method comprising:
receiving, by one or more processors, a request that identifies a first reference entry from a reference dataset, wherein:
(i) the first reference entry comprises (a) a binarized feature vector of a first dimension and (b) a latent representation of the binarized feature vector of a second dimension that is lower than the first dimension,
(ii) the first reference entry is identified based on the binarized feature vector, and
(iii) the latent representation of the binarized feature vector is generated by an encoder portion of an encoder-decoder machine-learned model that is previously trained using the reference dataset; and
determining, by the one or more processors, a matching score for a second reference entry from the reference dataset based on a difference between the latent representation and a second latent representation generated by the encoder for the second reference entry; and
outputting, by the one or more processors and based on the matching score meeting or exceeding a threshold score, the second reference entry in response to the request.

2. The computer-implemented method of claim 1, wherein the reference dataset is generated by:
generating, during a first stage, a first binarized feature vector indicating features of an input entity;
training, during a second stage, the encoder-decoder machine-learned model using the first binarized feature vector;
generating, during a third stage and using the encoder portion of the encoder-decoder machine-learned model, a first latent representation for the first binarized feature vector; and
storing the first binarized feature vector and the first latent representation within the reference dataset as a first reference entry.

3. The computer-implemented method of claim 1, wherein the encoder-decoder machine learned model is a variational autoencoder (VAE) model.

4. The computer-implemented method of claim 1, further comprising:
receiving a data record associated with an entity;
extracting a set of features from the data record to generate the binarized feature vector for the entity;
generating, by the encoder portion of the encoder-decoder machine learning model and based at least in part on the binarized feature vector, the latent representation;
generating the reference entry based on the binarized feature vector and the latent representation; and
storing the reference entry for the entity in the reference dataset.

5. The computer-implemented method of claim 4, wherein the binarized feature vector comprises a set of binary values that respectively correspond to a defined set of features and a binary value of the set of binary values identifies a presence or an absence of a feature from the defined set of features within the data record.

6. The computer-implemented method of claim 4, further comprising:
receiving a data entry for the reference entry;
extracting a new feature from the data entry that is absent from the set of features from the data record;
updating the binarized feature vector based on the new feature; and
regenerating, using the encoder portion of the encoder-decoder machine learning model, the latent representation of the binarized feature vector as an updated latent representation.

7. The computer-implemented method of claim 6, wherein updating the binarized feature vector comprises:
determining a feature index position within the binarized feature vector that corresponds to the new feature; and
modifying a binary value at the feature index position to indicate a presence of the new feature for the entity.

8. The computer-implemented method of claim 1, wherein the matching score is a cosine distance similarity measure between the latent representation of the first reference entry and another latent representation of the second reference entry.

9. The computer-implemented method of claim 8, wherein the threshold matching score is defined by the request.

10. A system comprising:
one or more processors; and
one or more memories storing processor-executable instructions that, when executed by the one or more processors, cause the one or more processors to perform operations comprising:
receiving a request that identifies a first reference entry from a reference dataset, wherein:
(i) the first reference entry comprises (a) a binarized feature vector of a first dimension and (b) a latent representation of the binarized feature vector of a second dimension that is lower than the first dimension,
(ii) the first reference entry is identified based on the binarized feature vector, and
(iii) the latent representation of the binarized feature vector is generated by an encoder portion of a variational autoencoder (VAE) model that is previously trained using the reference dataset; and
determining a matching score for a second reference entry from the reference dataset based on a difference between the latent representation and a second latent representation generated by the encoder portion for the second reference entry; and
outputting, based on the matching score meeting or exceeding a threshold score, the second reference entry in response to the request.

11. The system of claim 10, wherein generating the reference dataset comprises:
generating, during a first stage, a first binarized feature vector indicating features of an input entity;
training, during a second stage, the encoder-decoder machine-learned model using the first binarized feature vector;
generating, during a third stage and using the encoder portion of the encoder-decoder machine-learned model, a first latent representation for the first binarized feature vector; and
storing the first binarized feature vector and the first latent representation within the reference dataset as a first reference entry.

12. The system of claim 10, wherein the encoder-decoder machine learned model is a variational autoencoder (VAE) model.

13. The system of claim 10, wherein the one or more operations further comprise:
receiving a data record associated with an entity;
extracting a set of features from the data record to generate the binarized feature vector for the entity;
generating, by the encoder portion of the encoder-decoder machine learning model and based at least in part on the binarized feature vector, the latent representation;
generating the reference entry based on the binarized feature vector and the latent representation; and
storing the reference entry for the entity in the reference dataset.

14. The system of claim 13, wherein the binarized feature vector comprises a set of binary values that respectively correspond to a defined set of features and a binary value of the set of binary values identifies a presence or an absence of a feature from the defined set of features within the data record.

15. The system of claim 13, wherein the one or more operation further comprise:
receiving a data entry for the reference entry;
extracting a new feature from the data entry that is absent from the set of features from the data record;
updating the binarized feature vector based on the new feature; and
regenerating, using the encoder portion of the VAE model, the latent representation of the binarized feature vector as an updated latent representation.

16. The system of claim 15, wherein updating the binarized feature vector comprises:
determining a feature index position within the binarized feature vector that corresponds to the new feature; and
modifying a binary value at the feature index position to indicate a presence of the new feature for the entity.

17. The system of claim 15, wherein the matching score is a cosine distance similarity measure between the latent representation of the first reference entry and another latent representation of the second reference entry.

18. One or more non-transitory computer-readable storage media storing processor-executable instructions that, when executed by one or more processors, cause the one or more processors to perform operations comprising:
receiving a request that identifies a first reference entry from a reference dataset, wherein:
(i) the first reference entry comprises (a) a binarized feature vector of a first dimension and (b) a latent representation of the binarized feature vector of a second dimension that is lower than the first dimension,
(ii) the first reference entry is identified based on the binarized feature vector, and
(iii) the latent representation of the binarized feature vector is generated by an encoder portion of a variational autoencoder (VAE) model that is previously trained using the reference dataset; and
determining a matching score for a second reference entry from the reference dataset based on a difference between the latent representation and a second latent representation generated by the encoder portion for the second reference entry; and
outputting, based on the matching score meeting or exceeding a threshold score, the second reference entry in response to the request.

19. The one or more non-transitory computer-readable storage media of claim 18,
wherein the operations further comprise:
receiving a data record associated with an entity;
extracting a set of features from the data record to generate the binarized feature vector for the entity;
generating, by the encoder portion of the encoder-decoder machine learning model and based at least in part on the binarized feature vector, the latent representation;
generating the reference entry based on the binarized feature vector and the latent representation; and
storing the reference entry for the entity in the reference dataset.

20. The one or more non-transitory computer-readable storage media of claim 19,
wherein the operations further comprise:
receiving a data entry for the reference entry;
extracting a new feature from the data entry that is absent from the set of features from the data record;
updating the binarized feature vector based on the new feature; and
regenerating, using the encoder portion of the encoder-decoder machine learning model, the latent representation of the binarized feature vector as an updated latent representation.
